(19) United States
(12) Patent Application Publication
(10) Pub. No.: US 2009/0144835 A1
(43) Pub. Date: Jun. 4, 2009

(54) System, method and computer-readable medium for providing a unifed computer-mediated purchasing experience

(76) Inventor: Harold Lee Peterson, Scotts Valley, CA (US)

Correspondence Address: PATRICK REILLY, P.O. BOX 7218, SANTA CRUZ, CA, 95061-7218, US

(21) Appl. No.: 11/998,837

(22) Filed: Nov. 30, 2007

(51) Int. Cl. H04L 9/32; G06F 3/00

(52) U.S. Cl. 726/29; 715/738

(57) ABSTRACT

A method, system and computer-readable medium are provided to enable in an electronic communications network comprising a client system, an order processing computer and a plurality of fulfillment systems, a method for processing purchase requests. The method may include (a.) providing a managed client with user interface and navigation on the client system to a user, the user interface enabling a user to place purchase requests via the client system; (b.) transmitting at least one purchase request from the client system to the order processing computer; and (c.) enabling the order processing computer to direct at least one fulfillment system to execute at least one aspect of the at least one purchase request. The at least one fulfillment system may authorize an execution of a software by the client system, authorize a webservice, and/or a download of data to the client system.

### FIELD OF THE INVENTION

The present invention relates to an online shopping system for a user to order and purchase items and more particularly to a system and method for providing an electronic shopping system having integrated shopping cart functionality.

### BACKGROUND OF THE INVENTION

Tens of billions of US dollars of goods and services are presently purchased annually by means of computational devices, such as cell phones and networked personal computers. Numerous merchants and service providers strive to enable potential customers and clients to conveniently select services and items for purchase and as presented on informational technology devices. The prior art includes efforts to allow a consumer to place orders for goods and services in a various ways.

In particular, U.S. Pat. No. 7,287,003 teaches an integrated electronic shopping cart system and method; U.S. Pat. No. 7,272,571 presents a method and apparatus for effective distribution and delivery of goods ordered on the World-Wide-Web; U.S. Pat. No. 7,249,056 discusses a method and system for exchanging data between affiliated sites; U.S. Pat. No. 7,197,475 discloses a multi-vendor internet commerce system for e-commerce applications and methods therefore; U.S. Pat. No. 7,188,081 presents an electronic shopping basket; U.S. Pat. No. 7,162,443 describes a method and computer readable medium storing executable components for locating items of interest among multiple merchants in connection with electronic shopping; U.S. Pat. No. 6,850,900 discloses a full service secure commercial electronic marketplace; U.S. Pat. No. 6,665,577 teaches a system, method and article of manufacture for automated fit and size predictions; U.S. Pat. No. 6,499,052 discloses an electronic commerce system for referencing remote commerce sites at a local commerce site; U.S. Pat. No. 6,405,176 presents a method for processing multiple electronic shopping carts; U.S. Pat. No. 6,101,482 discusses a universal web shopping cart and method of on-line transaction processing; United States Patent Application Publication No. 20060041485 presents a universal shopping cart and order injection system; and United States Patent Application Publication No. 20020038255 also presents a Universal shopping cart and order injection system.

It is understood that each and every patent and patent application referenced in this present patent application, to include U.S. Pat. Nos. 7,287,003; 7,272,571; 7,249,056; 7,197,475; 7,188,081; 7,162,443; 6,850,900; 6,665,577; 6,499,052; 6,405,176; and 6,101,482; and United States Patent Application Publication No.'s 20060041485 and 20020038255, are hereby incorporated by reference in their entirety and for all purposes in this present patent application.

The prior art fails to optimally present a unified environment for the purchase of goods and services from a variety of sources.

### SUMMARY OF THE INVENTION

Towards this object and other objects that will be made obvious in light of this disclosure, a first version of the method of the present invention provide a computer network that includes a client system and an order processing computer. The client system includes a client system interface configured to generate a unified user experience for purchasing goods and services from the Internet and enable access to a software program stored on the client system. The order processing computer is configured to accept purchase requests from the client system and to direct both the client system and the Internet to fulfill purchase requests generated from the client system interface. The order processing computer may be further configured to authorize a user access to a software stored on the client system prior to issuance of a purchase request, wherein the software may be stored on a hard disc of the client system prior to issuance of a purchase request. The computer network may further optionally comprise means to complete a financial transaction authorized by a user generated billing authorization prior to authorization of fulfillment of an associated purchase request.

A first preferred method of the present invention enables, in an electronic communications network comprising a client system, an order processing computer and a plurality of fulfillment systems, a method for processing purchase or access requests. The first method includes the aspects of (a.) providing a managed client with a user interface having a navigation software tool on the client system to a user, the user interface enabling a user to place purchase requests via the client system; (b.) accepting at least one purchase request by the client system to the order processing computer; (c.) when the client system is not in communication with the order processing computer, temporarily enabling the client system to fulfill the purchase request; and (d.) when the client system is in communication, enabling the order processing computer to direct at least one fulfillment system to execute at least one aspect of the at least one purchase request. The at least one fulfillment system may take authorize an execution of a software by the client system, authorize a webservice, authorize a download of data to the client system, electronically transmit an authorization code, direct a shipment of a product, direct a mailing of a hard copy certificate, authorize a consumer service, authorize a business service, authorize a recordation of a document, and/or issuing a notification.

Certain alternate preferred embodiments of the method of the present invention may additionally, alternatively, or optionally include one or more aspects of (a.) a receipt by the order processing computer of a billing authorization associated with the at least one purchase request from the client; (b.) the order processing computer completing a financial transaction authorized by the billing authorization prior to direction of the at least one fulfillment system by the order processing computer; including the Internet within the electronic communications network; streaming a download of data via the Internet and to the client system; comprising a webpage within the user interface; the order processing computer authorizes execution of a software, the software substantially stored on the client system prior to transmission of the at least one purchase request; the order processing computer enabling to authorize execution of the software, whereby no intermediation of a fulfillment system is required to fulfill a purchase request to execute the software; a software substantially stored on a hard disc of the client software prior to generation of the at least one purchase request and made accessible to a user after the generation of a purchase request.

Certain still alternate preferred embodiments of the method of the present invention provide a method for facilitating purchasing transactions using the Internet. These alternate methods may additionally, alternatively or optionally include on or more aspects of: (a.) providing a managed client with user interface and navigation via a client system of the Internet, whereby the user may purchase access to or ownership of goods or services; (b.) enabling the user interface to provide a unified user experience, wherein the user may purchase both (1.) authorization to a service enabled by a software stored on the client system prior to an authorization purchase by the user and (2.) an additional good or service purchased via the Internet within the unified user experience; and/or (c.) an order processing computer, the order processing computer comprised within the Internet and configured to (1.) accept a purchase order transmitted from the client system, (2.) enable authorization to the service enabled by the software stored on the client system, and (3.) direct the Internet to enable fulfillment of an additional aspect of the purchase order.

Certain yet alternate preferred embodiments of the method of the present invention comprise a computer-readable medium having computer-executable components for providing a web page comprising a consistent user interface enabled to direct the computer system to execute the method of claim 1 and/or other aspects of the method of the present invention.

The foregoing and other objects, features and advantages will be apparent from the following description of the preferred embodiment of the invention as illustrated in the accompanying drawings.

### BRIEF DESCRIPTION OF THE DRAWINGS

These, and further features of the invention, may be better understood with reference to the accompanying specification and drawings depicting the preferred embodiment, in which:

FIG. 1 is an illustration of a first preferred alternate embodiment of the method of the present invention (hereafter “first method”);

FIG. 2 is an illustration of additional optional aspects of the first method;

FIG. 3 is an illustration of a first alternate preferred embodiment of the present invention, or “first version”;

FIG. 4 is a schematic diagram of a client system of FIG. 3;

FIG. 5 is a software flowchart of an execution of a purchasing software of the first method of FIGS. 1 and 2 as executed by the first version of FIG. 3;

FIGS. 6A and 6B comprise a flowchart of the operations of the client system of FIGS. 3 and 4 in execution of certain aspects of the first method of FIGS. 1 and 2;

FIG. 7 is a software flowchart of aspects of the first method of FIGS. 1 and 2 that may preferably be performed when the client system of FIGS. 3 and 4 is not currently in communications an ordering system of FIGS. 3 and 4;

FIG. 8 is a software flowchart of certain operations of an ordering system of FIGS. 3 and 4 and in accordance with the first method;

FIG. 9 is a flowchart of a second alternate preferred embodiment of the method of the present invention, or “second method”;

FIG. 10 is a schematic of a formatted electronic message of a purchase request as transmitted from the client system of FIGS. 3 and 4 to an ordering system of FIGS. 3 and 4;

FIG. 11 is a schematic diagram of a fulfillment electronic message containing information that enables the client system of FIGS. 3 and 4 to receive a download of a an externally stored software program;

FIG. 12 is a schematic of a product software database maintained by a client system of FIGS. 3 and 4;

FIG. 13 is an ordering software database that is maintained by a ordering system of FIGS. 3 and 4;

FIG. 14 is a schematic diagram of a client software of the client system of FIGS. 3 and 4;

FIG. 15 is a schematic diagram of an ordering system software of an ordering system of FIGS. 3 and 4;

FIG. 16 is a screen shot of a product/service ordering menu as visually presented by a video display module of the client system of FIGS. 3 and 4;

FIG. 17 is a screen shot of a credit information input form as visually presented by a video display module of the client system of FIGS. 3 and 4; and

FIG. 18 is a screen shot of a shipping information input form as visually presented by a video display module of the client system of FIGS. 3 and 4.

### DETAILED DESCRIPTION OF A PREFERRED EMBODIMENT

In describing the preferred embodiments, certain terminology will be utilized for the sake of clarity. Such terminology is intended to encompass the recited embodiment, as well as all technical equivalents, which operate in a similar manner for a similar purpose to achieve a similar result.

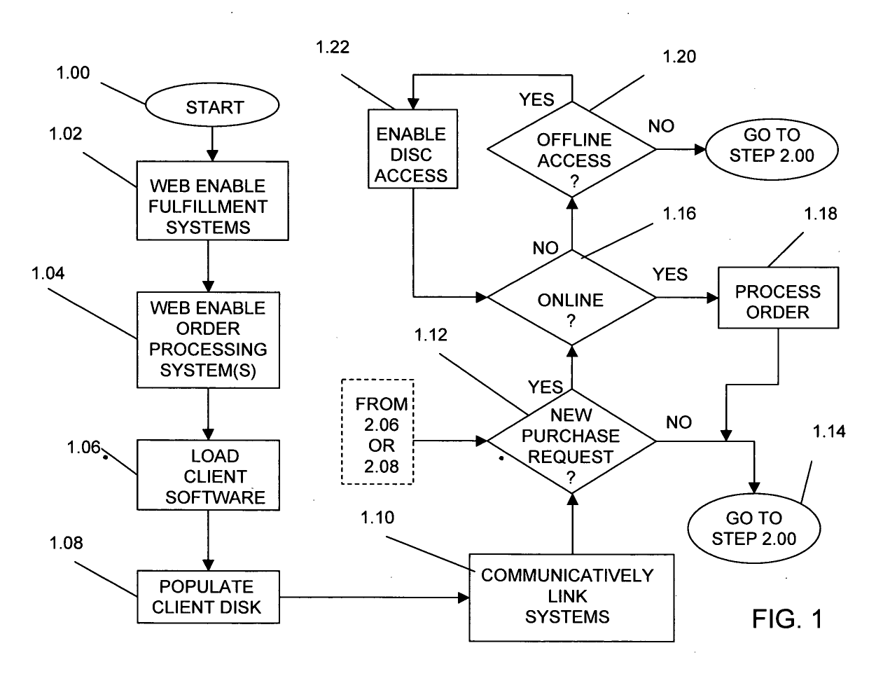

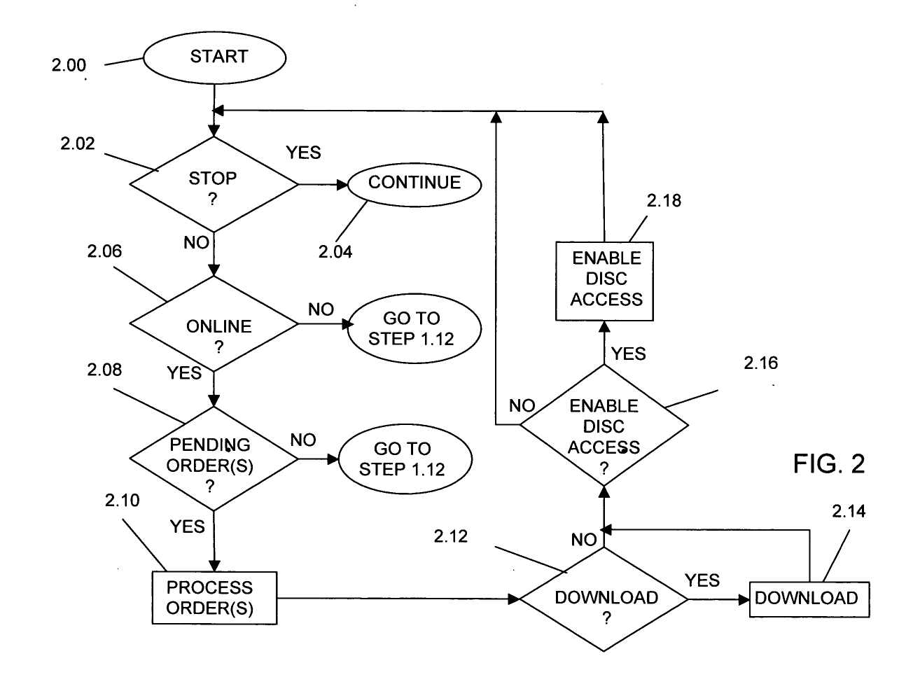

Referring now generally to the Figures and particularly to FIGS. 1 and 2, FIGS. 1 and 2 are illustrations of a first preferred alternate embodiment of the method of the present invention (hereafter “first method”). As presented in FIG. 1, a plurality of fulfillment systems 2 are web enabled in step 1.02, at least one order processing system 4 is web enabled in step 1.04, an a client software CSW is loaded onto a client system 6 in step 1.06. A memory disc 8 of the client system 6 is populated with a purchasing software client PSW and optionally a first software product SW.1 and/or one or more of a plurality of software products SW.2-SW.N. In step 1.10 the fulfillment systems 2 (hereafter, “Fsystems” 2), one or more ordering systems 4 (hereafter “Osystems” 4), and at least one client system 6 are communicatively coupled with the Internet 10. It is understood that in certain alternate preferred embodiments of the method of the present invention the Internet 10 may be substituted with one or more alternate electronic communications networks 11, wherein the selected electronic communications network 11 may be, comprise, or be comprised within an extranet, an intranet, computer network, a telephony network, a wireless communications network 11A, and/or a wireless telephony network. The wireless communications network 11A may, comprise or be comprised within, a wireless telephony network.

In step 1.12 the client system 6 determines whether a user has made a purchase request as enabled by the purchasing software client PSW. When the client system 6 determines in step 1.12 that no purchase request has been received, and that no previously generated purchase request remains to be processed, as initiated by a user via the purchasing software PSW, the client system 6 proceeds from step 1.12 to step 1.14 and therefrom to step 2.00. When the client system 6 determines in step 1.12 that an unprocessed purchase request has been received from a user via the purchasing software PSW, the client system 6 proceeds from step 1.12 to step 1.16 and to determine whether the client system 6 may currently electronically communicate with one or more Osystems 4. When the client system 6 determines in step 1.12 that electronic communication may be affected between the client system 6 and at least one Osystem 4, the client system 6 proceeds in step 1.18 to process one or more pending purchase requests in coordination with at least one Osystem 4.

When the client system 6 determines in step 1.12 that electronic communication may not currently be affected between the client system 6 and at least one Osystem 4, the client system 6 proceeds onto step 1.20 and to determine whether the unfulfilled purchase request detected in step 1.12 may be at least partially fulfilled by enabling access to one or more software products SW.1-SW.N as presently stored within the client system 6, e.g., on the disc memory 8 of the client system 6. Where access to at least one software product SW.1-SW.N is requested by at least one unprocessed purchase request, the client system 6 proceeds from step 1.20 to step 1.22 and to enable access to one or more software products SW.1-SW.N as requested by one or more unprocessed purchase requests.

It is understood that the term “unprocessed purchase request” is defined herein to include a purchase request generated by the client system 6 and intended for transmission to at least one Osystem 4, but not yet transmitted to an Osystem 4 at the time of execution of step 1.16. It is also understood that, in certain alternate preferred embodiments of the method of the present invention, a determination of the client system 6 being “currently” in communication with at least one Osystem 4 may require that communication with at least one Osystem 4 and the client system 6 be successfully initiated within 30 seconds of a detection in step 1.12 of an unprocessed purchase request, or more preferably within 3 seconds of a detection in step 1.12 of an unprocessed purchase request.

Where access to at least one software product SW.1-SW.N is not requested by an unprocessed purchase request, the client system 6 proceeds from step 1.20 to step 2.00.

Referring now generally to the Figures and particularly to FIG. 2, FIG. 2 is an illustration of additional optional aspects of the first method. The client system 6 determines in step 2.02 whether to continue information and communications processing in accordance with the first method, or to proceed on to step 2.04 and to power down and/or to proceed on to perform alternate computational processes. When the client system 6 determines in step 2.02 to continue to perform in accordance with the first method, the client system 6 proceeds from step 2.02 to step 2.06 and to determine whether the client system 6 is currently in communication with at least one Osystem 4. When the client system 6 determines in step 2.06 that the client system 6 is not currently in communication with at least one Osystem 4, the client system 6 proceeds from step 2.06 to step 1.12 of FIG. 1.

When the client system 6 determines in step 2.06 that the client system 6 is currently in communication with at least one Osystem 4, the client system 6 proceeds from step 2.06 to step 2.08 to determine whether any unfulfilled purchase requests are pending in accordance with the purchasing software PSW. When the client system determines in step 2.08 that no unfulfilled purchase requests are pending, the client system 6 proceeds from step 2.08 to execute step 1.12 of FIG. 1. When the client system determines in step 2.08 that at least one unfulfilled purchase request is pending, as generated by the purchasing software PSW of the client system 6, the client system 6 proceeds from step 2.08 to step 2.10 and to process the pending purchase request(s) in coordination with at least one Osystem 4.

In step 2.12 the client system 6 determines whether one or more unfulfilled purchase requests as generated by the client system 6 have resulted in a external software program XSW.1-XSW.N being downloaded either from one or more Osystems 4 or one or more Fsystems 2 to the client system 6. In step 2.14 one or more downloads of at least one external software program XSW.1-XSW.N are performed.

In step 2.16 the client system 6 determines whether one or more unfulfilled purchase requests as generated by the client system 6 include a request to access one or more software products SW.1-SW.N as stored on the hard disc 8 of the client system 6. In step 2.18 access to at least one software product SW.1-SW.N stored on the memory disc 8 is enabled.

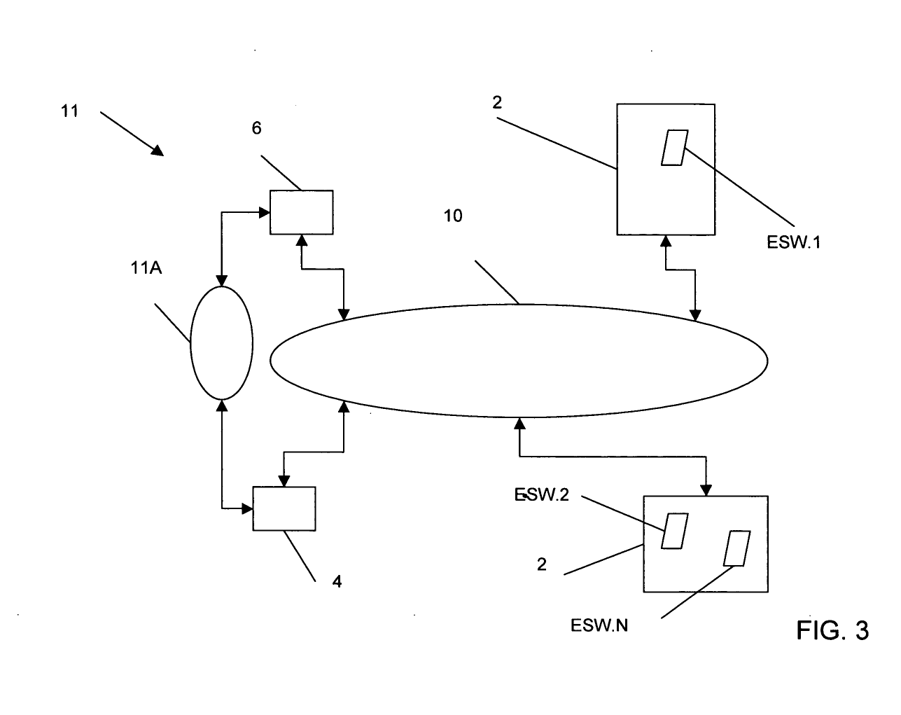

Referring now generally to the Figures and particularly to FIG. 3, FIG. 3 is an illustration of a first alternate preferred embodiment of the present invention (hereafter “first version”). The electronics communications network 11 includes the Internet 10, a plurality of Fsystems 2, at least one Osystem 4, and at least one client system 6. As disclosed above, the electronic communications network 11 may be, comprise, or be comprised within the Internet 10, an intranet, an extranet, a computer network, a telephony network, the wireless communications network 11A, and/or a wireless telephony network. The wireless communications network 11A may, comprise or be comprised within, a wireless telephony network. The plurality of Fsystems 2 are bi-directionally communicatively coupled with at least one Osystem 4 by means of the Internet 10, and at least one client system 6 is bi-directionally communicatively coupled with at least one Osystem 4 by the Internet 10 and/or the wireless communications network 11A.

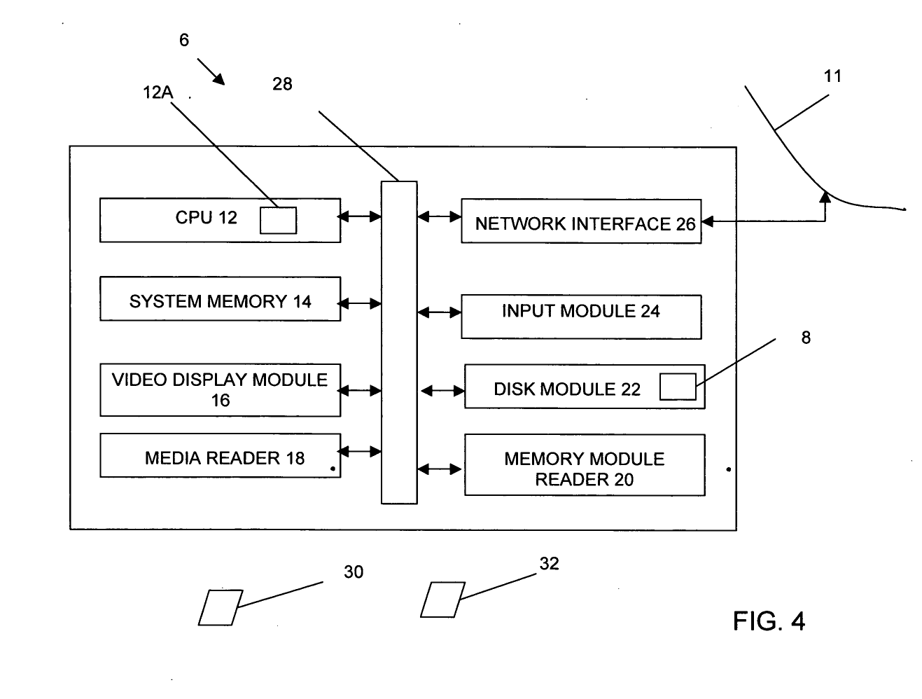

Referring now generally to the Figures and particularly to FIG. 4, FIG. 4 is a schematic diagram of the client system 6. The client system 6, one or more Osystems 4 and one or more Fsystems 2 may be, comprise or be comprised within (1.) a SOLARIS SPARCSERVER computer workstation marketed by Sun Microsystems of Santa Clara, Calif. running LINUX™ or UNIX™ operating system; (2.) a personal computer configured for running WINDOWS XP™ operating system marketed by Microsoft Corporation of Redmond, Wash. (3.) a VAIO FS8900™ notebook computer marketed by Sony Corporation of America, of New York City, N.Y.; or a (4.) POWERBOOK G4™ personal computer marketed by Apple Computer, Inc., of Cupertino, Calif.

A central processing unit 12 (hereafter, “CPU” 12), a system memory 14, a display module 16, a media reader 18, a memory module reader 20, a memory disc module 22, a user input module 24 and a network interface circuit 26 are bi-directionally communicatively coupled by means of an internal communications bus 28. The CPU 12 may be a digital electronic microprocessor that contains a real-time clock 12A, such as an a PENTIUM V™ microprocessor marketed by Intel Corporation of Santa Clara, Calif. or an ATHLON™ microprocessor marketed by AMD corporation of Sunnyvale, Calif. A system memory 14 may contain some or all of the client system software CSW, software products SW.1-SW.N, and/or the purchasing software PSW in whole or in part and as further described herein. The media reader 18 is configured to read from, and optionally write to an electronic media 30. The electronic media 30 may contain some or all of the client system software CSW, software products SW.1-SW.N, and/or the purchasing software PSW in whole or in part and as further described herein. A memory module reader 20 is configured to read from, and optionally write to, a secondary electronic media 32. The secondary electronic media 32 may contain some or all of the client system software CSW, software products SW.1-SW.N, and/or the purchasing software PSW in whole or in part and as further described herein

The electronic media 30 and/or the secondary electronic media 32 are each computer-readable media may be or comprise an electronic solid state memory, random access memory, programmable memory, field programmable memory, a floppy disc, a flexible disc, hard disc, magnetic tape, or any suitable other magnetic medium known in the art, ma CD-ROM, other suitable optical medium known in the art, a PROM, and EPROM, a FLASH-EPROM, any other suitable memory chip or cartridge known in the art, or any other suitable medium known in the art from which a computer can read machine executable instructions.

The term “computer-readable medium” as used herein refers to any suitable medium known in the art that participates in providing instructions to the network for execution. Such a medium may take many forms, including but not limited to, non-volatile media and volatile media. Non-volatile media includes, for example, optical or magnetic discs, tapes and thumb drives. Volatile media includes dynamic memory. Common forms of computer-readable media include, for example, a floppy disc, a flexible disc, hard disc, magnetic tape, or any other magnetic medium, a CD-ROM, any other optical medium, RAM, a PROM, and EPROM, a FLASH-EPROM, any other memory chip or cartridge, or any other suitable medium known in the art from which a computer can read machine executable instructions.

The disc module 22 is a memory disc drive that includes the memory disc 8 and is configured to read and write to and from the memory disc 8. The memory disc 8 may a compact disc read only memory (or “CD-ROM”), a digital video disc (or “DVD”). The disc module 22 may be configured (a) as an internal hard drive that permanently or semi-permanently retain a single or multiple memory discs 8, or (b.) to enable removal and insertion of a plurality of memory discs 8.

The input module 24 may comprise an electronic typeface keyboard and/or a point and click selection device, e.g., a computer mouse, an optical mouse, or a touch pad. The network interface circuit 26 may be configured to bi-directionally couple the CPU 12 and the internal communications 28 with the communications network 11, the Internet 10, and/or the wireless communications network 11A.

In certain alternate preferred embodiments of the method of the present invention the client system 6, and one or more Fsystems 2 and/or Osystems 4 may be, comprise, or be comprised within, a cellular telephone, a personal digital assistant or a computer. For example, the client system 6, and one or more Fsystems 2 and/or Osystems 4 may be selected from a group of electronic devices including (1.) a Nokia Model E61™ cellular telephone marketed by Nokia Corporation of Espoo Finland; (2.) a BLACKBERRY™ wireless personal digital assistant marketed by Research-in-Motion of Waterloo, Ontario, Canada; (3.) a VAIO FS8900™ notebook computer marketed by Sony Corporation of America, of New York City, N.Y.; and (4.) POWERBOOK G4™ personal computer marketed by Apple Computer, Inc., of Cupertino, Calif. The bi-directional communicative coupling between the communications network 11 and the computational device may be accomplished by radio frequency transmissions, wherein the network interface circuit 26 is a wireless communications module and includes an antenna.

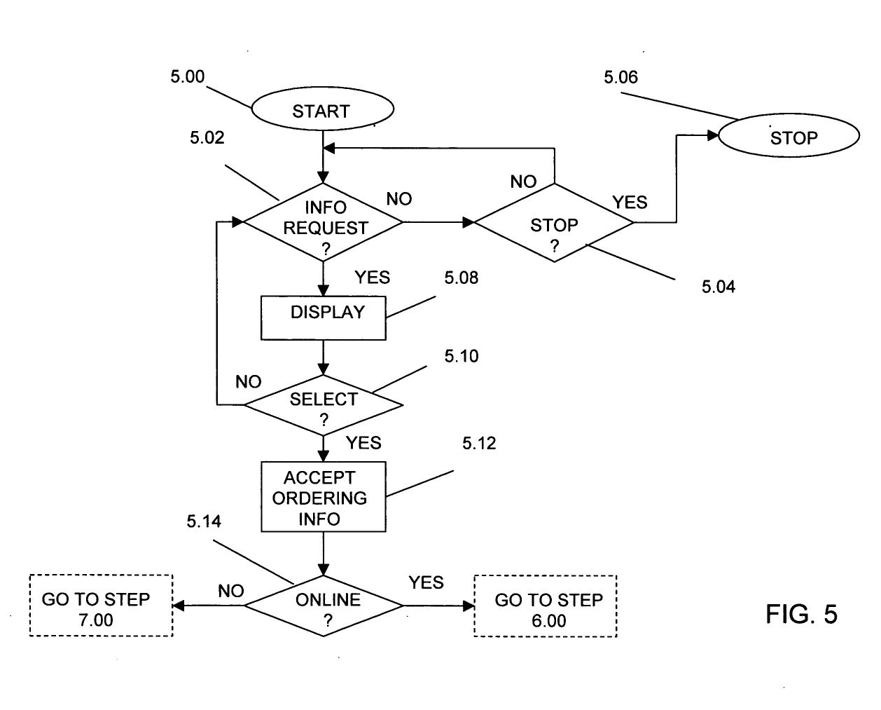

Referring now generally to the Figures and particularly to FIG. 5, FIG. 5 is a software flowchart of an execution of the purchasing software PSW as executed by the client system 6. In step 5.02 the client system 6 determines whether the user has requested by means of the input module 24 a presentation of a purchase selection menu PM. When the client system 6 determines in step 5.02 that no unfulfilled request for a presentation of the purchase selection menu PM is presently pending, the client system 6 proceeds from step 5.02 to step 5.04 to further determine whether to continue information and communications processing in accordance with the first method, or to proceed on to step 5.06 and to power down and/or to proceed on to perform alternate computational processes.

When the client system 6 determines in step 5.02 that an unfulfilled request by the user for a presentation of the purchase selection menu PM is presently pending, the client system 6 proceeds from step 5.02 to step 5.08 and to display the purchase selection menu PM on the video display module 16.

In step 5.10 the client system 6 determines whether the user has made a selection by means of the input module 24 to indicate an intent to purchase (a.) access to a software product SW.1-SW.N, (b.) an external software ESW.1-ESW.N, (c.) and/or other goods or services. When the client system 6 determines in step 5.10 that the user has not indicated an intention to issue a purchase request, the client computer 6 proceeds from step 5.10 and back to step 5.02. Alternatively, when the client system 6 determines in step 5.10 that the user has indicated an intention to issue a purchase request, the client computer 6 proceeds from step 5.12 and accepts purchasing information from the user via the input module 24 and generates a purchase request. When the client system 6 is currently online and in communication with at least one Osystem 4, the client system 6 proceeds from step 5.14 to step 6.00. Alternatively, when the client system 6 is not currently in communication with at least one Osystem 4, the client system 6 proceeds from step 5.14 to step 7.00.

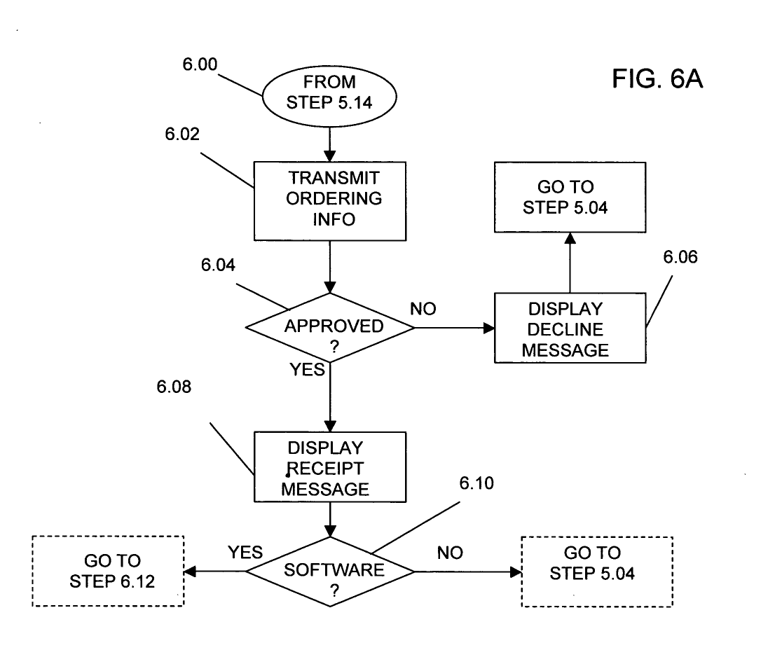

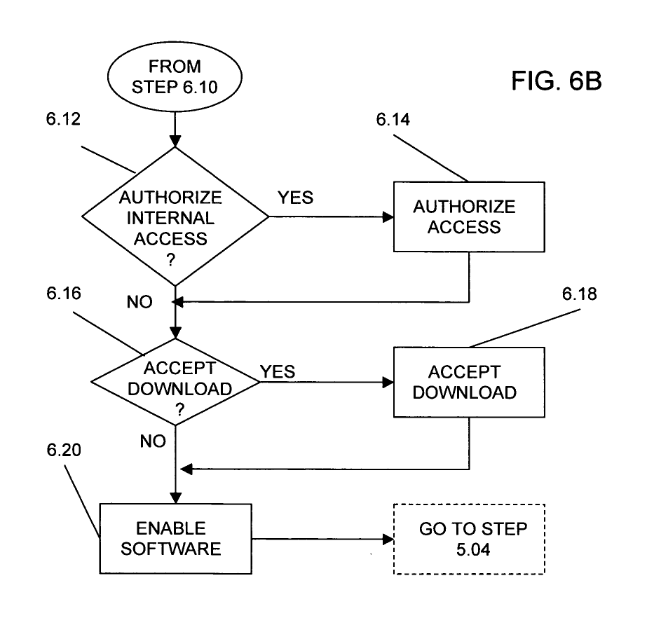

Referring now generally to the Figures and particularly to FIGS. 6A and 6B, FIGS. 6A and 6B comprise a flowchart of the operations of the client system 6 in execution of certain aspects of the first method. In step 6.02 a purchase request is transmitted from the client system 6 and via the communications network 11, e.g., the Internet 10 and/or the wireless communications network 11A, to at least one Osystem 4. In step 6.04 the client system 6 determines whether the purchase requested by the information provided in step 6.02 has been approved or declined by at least one Osystem 4. When the client system 6 is informed by the Osystem 4 in step 6.04 that the purchase request of step 6.02 has been declined, the client system proceeds from step 6.04 to step 6.06 and to present a sales decline message to the user by means of the video display module 16.

When the client system 6 is informed by the Osystem 4 in step 6.04 that the purchase request of step 6.02 has been approved, the client system proceeds from step 6.04 to step 6.08 and to present a sales approval and purchase message to the user by means of the video display module 16. When the good(s) or service(s) designated in step 6.08 as approved for purchase include access to or purchase of software code available via download from the communications network 11, stored within the client system 6, upload from available electronic media 30, 32 or 8, the client system 6 proceeds from step 6.10 to step 6.12 of FIG. 6B. When the good(s) or service(s) designated in step 6.08 as approved for purchase do not include access to or purchase of software via download from the communications network 11 or upload from available electronic media 30, 32, 8 or stored on the system memory 14, the client system 6 proceeds from step 6.10 to step 5.02.

Referring now generally to the Figures and particularly to FIG. 6B, FIG. 6B is a flowchart of the operation of the first client system 6 in further execution of additional, alternative and/or optional aspects of the first method. In step 6.12 the client system 6 determines whether the Osystem 4 has communicated in step 6.04 an authorization to access software available in the system memory 14, electronic media 30 or 32, and or the memory disc 8. When an authorization to access of locally stored software code had been received by the client system 6 in step 6.04, the client system 6 may proceed from to authorize access to a locally stored software SW.1-SW.2 and optionally upload the indicated software program SW.1-SW.N from electronic media 30 or 32 in step 6.14.

When an authorization to download an external software program ESW.1-ESW.N had been received by the client system 6 in step 6.04, the client system 11 may proceed from step 6.16 to step 6.18 and receive a download of an external software program ESW.1-ESW.N

In step 6.10 the client system 6 enables access one or more the software products SW.1-SW.N as authorized in step 6.14 and/or at least one external software program ESW.1-ESW.N downloaded in step 6.18. The client system 6 proceeds from step 6.20 to step 5.04.

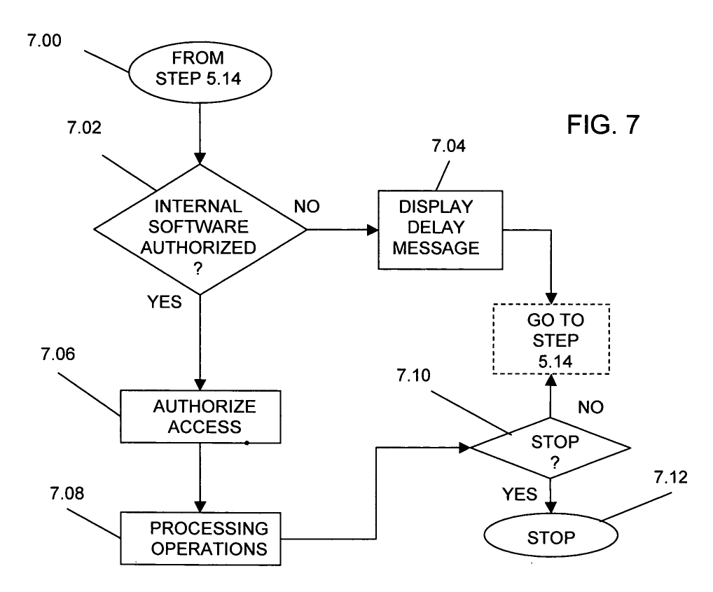

Referring now generally to the Figures and particularly to FIG. 7, FIG. 7 is a software flowchart of aspects of the first method that may preferably be performed when the client system 6 is not currently in communications with an Osystem 4. In step 7.02 the client system 6 determines whether the ordering information of step 5.12 indicates a request by the user to access a software product SW.1-SW.N that is presently available at least in part, and authorized for user access upon request at least, within the client system 6 or by upload from the memory disc 8, or electronic media 30 or 32. Where there is no software product SW.1-SW.N that is (1.) indicated as requested for user access; and (2.) available for user access within the client system 6 or by upload from a disc memory 8 or electronic media 30 or 32, the client system 6 proceeds on to step 7.04 and to display a delay message via the video display module 16 to inform the user that communication with at least one Osystem 4 is not currently available from the client system 6.

When the client system 6 determines in step 7.02 that a software product SW.1-SW.N that is determined as requested for user access and is available for user access within the client system 6 or by upload from a disc memory 8 or electronic media 30 or 32, the client system 6 proceeds on to step 7.04 and to 7.06 and to authorize access to the indicated software product SW.1-SW.N.

The client system 8 proceeds from step 7.6 to computational process operations, which may include the execution of the software product SW.1-SW.N authorized for access in step 7.06. The client system 6 proceeds from step 7.08 to step 7.10 to further determine whether to continue information and communications processing in accordance with the first method, or to proceed on to step 7.12 and to power down and/or to proceed on to perform alternate computational processes. The first system 6 may alternatively proceed from step 7.10 to step 5.14 of FIG. 5.

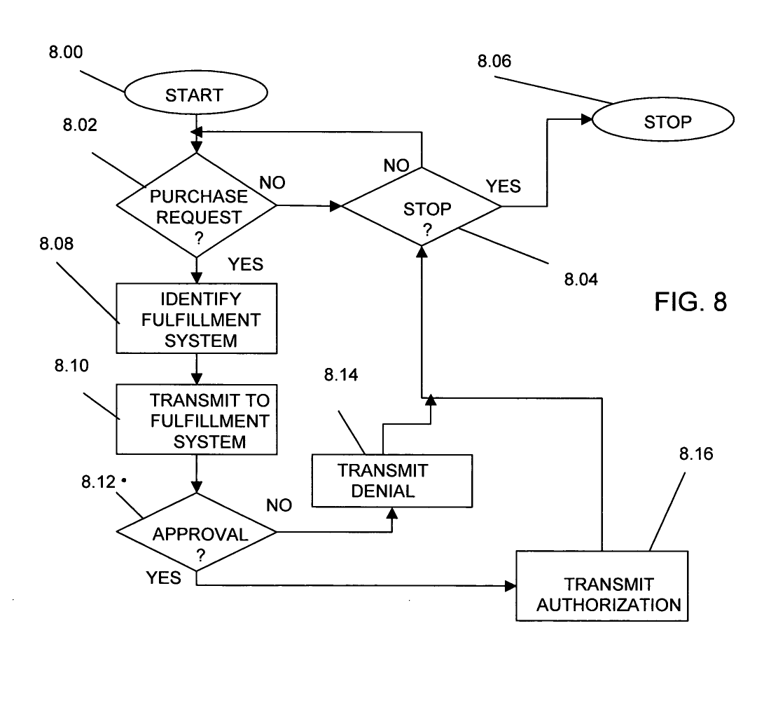

Referring now generally to the Figures and particularly to FIG. 8, FIG. 8 is a software flowchart of certain operations of at least one Osystem 4 (or “host Osystem” 4) in accordance with the first method. In step 8.02 the host Osystem 4 determines whether a purchase request has been received from the client system 6 via the communications network 11. When the host Osystem 4 determines in step 8.02 that there is no unfulfilled and pending purchase request received from the client computer 6, the Osystem 4 proceeds from step 8.02 to step 8.04 and to further determine whether to continue information and communications processing in accordance with the first method, or to proceed on to step 8.06 and to power down and/or to proceed on to perform alternate computational processes.

When the host Osystem 4 determines in step 8.02 that there is an unfulfilled and pending purchase request received from the client computer 6, the Osystem 4 proceeds from step 8.02 to step 8.08. The host Osystem 4 identifies one or more Fsystems 2 that may have the capability to fulfill at least part of the purchase request of the client computer 6, and in step 8.10 the host Osystem 4 transmits financial billing and product identification information received from the client system 4 to at least one Fsystem 2 selected in step 8.08.

In step 8.12 the host Osystem 4 determines whether at least one Fsystem 2 has transmitted an approval of the forwarded purchase request of step 8.10. When the host Osystem 4 determines that at least one Fsystem 2 has declined to authorize the purchase request of step 8.10, the host Osystem 4 proceeds from step 8.12 to 8.14 and transmits a denial of authorization via the communications network 11 to the client system 6 to inform the user. Alternatively, \hen the host Osystem 4 determines that at least one Fsystem 2 has approved and authorized the purchase request of step 8.10, the host Osystem 4 proceeds from step 8.12 to 8.15 and transmits an authorization via the communications network 11 to the client system 6 to inform the user of the approved purchase, and optionally to the enable the client system to access, download, or upload a software product SW.1-SW.N or external software program ESW.1-ESW.N.

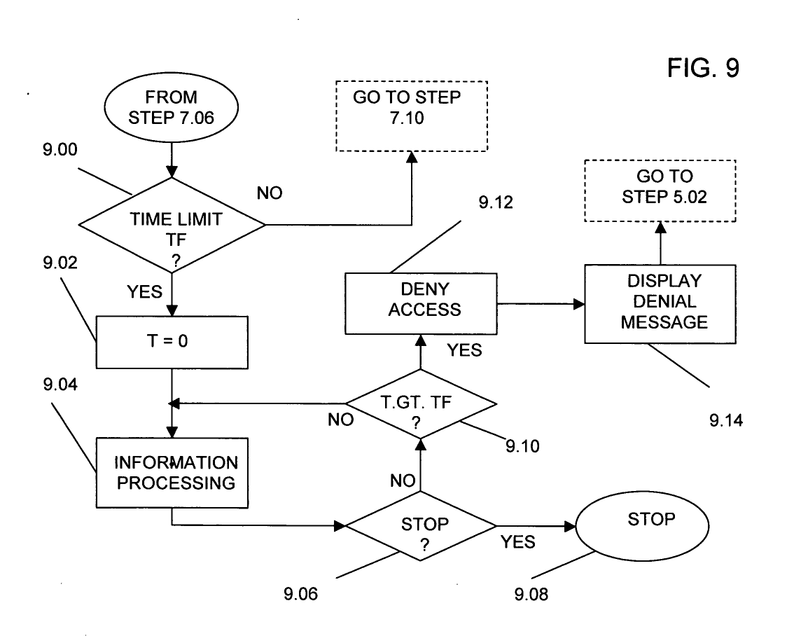

Referring now generally to the Figures and particularly to FIG. 9, FIG. 9 is a flowchart of a second alternate preferred embodiment of the method of the present invention (hereafter, “second method”). In the second method, a first software product SW.1 has a time limit TF during which the first software product SW.1 may be at least partially accessed by a user while either (a.) the client system is offline, and/or (b.) an access request has been transmitted from the client system 6 and to at least one Osystem 4 but no access approval has yet been received by the client computer 6. The access time period for the first software product SW.1 (a.) begins at an access start time determined at step 9.02 and after from executing step 7.06; and (b.) ends after a time length of TF has elapsed after the access start time. The client system 6 determines in step 9.00 if the software product SW.1-SW.N indicated for purchase in step 5.12 has an offline access time limitation parameter TF. If the client system 6 determines that the software product SW.1-SW.N indicated for purchase in step 5.12 does not have an offline access time limitation parameter TF, the client computer 6 proceeds from step 9.00 to step 7.10.

Alternatively, when the client system 6 determines in step 9.00 that the software product SW.1-SW.N indicated for purchase in step 5.12 does have an offline access time limitation parameter TF, the client computer 6 proceeds from step 9.00 to step 9.02 and to set a time variable T equal to zero.

In step 9.04 the client system 6 performs information processing operations, and the variable T is incremented according to the real time clock 12A of the client system 6. When T is found to exceed TF in an execution of step 9.10, the client system 10 proceeds to deny access to the first software product SW.1 by the user in step 9.12 and in step 9.24 to present a denial of use message via the video display module 16 to inform the use of the termination of access privileges to the first software product SW.1.

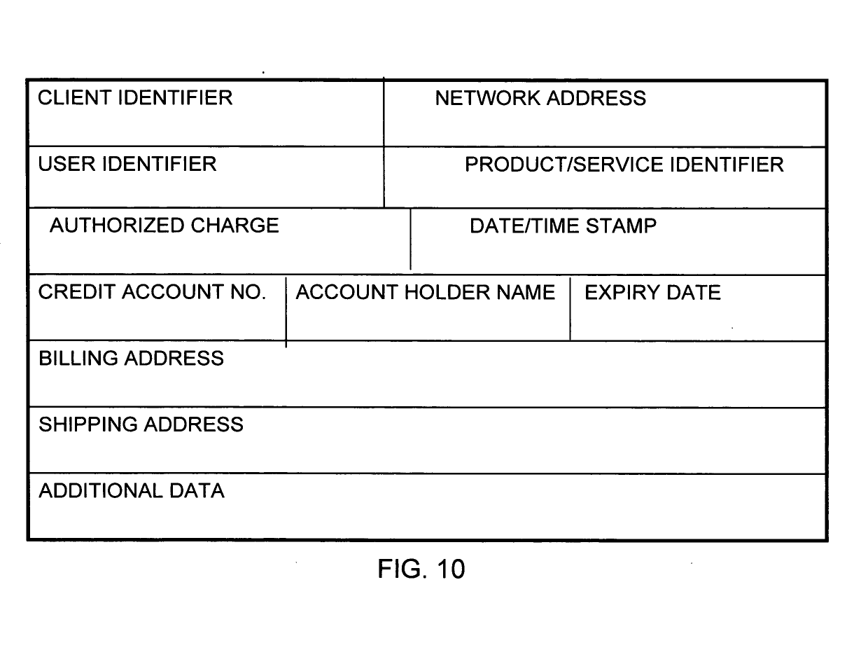

Referring now generally to the Figures and particularly to FIG. 10, FIG. 10 is a schematic of a formatted electronic message of a purchase request as transmitted from the client system 6 to an Osystem 4. The purchase request electronic message (hereafter, “purchase message”) includes (a.) a client system identifier that is associated with the client system 6 by the Osystem 4, (b.) a network address of the client system 6, (c.) a user identifier that is associated with the self-identification of the user, and (d.) a product/service identifier PID associated with a product or service that the user is requesting to purchase. The purchase message also includes an authorized charge amount as entered by the user into the client system 6 and a date and time/stamp of the issuance of the purchase message by the user by means of the client system 6. The purchase request further includes credit card billing and shipping address information, to include (a.) a financial credit account number, (b.) a name associated by the issuer of the instant credit account as the name of the account holder, (c.) an expiry date of the credit account or a credit card associated with the aforementioned credit account, (d.) a billing address for the instant credit account, and (e.) an optional shipping address for the good or service indicated by the product/service identifier PID.

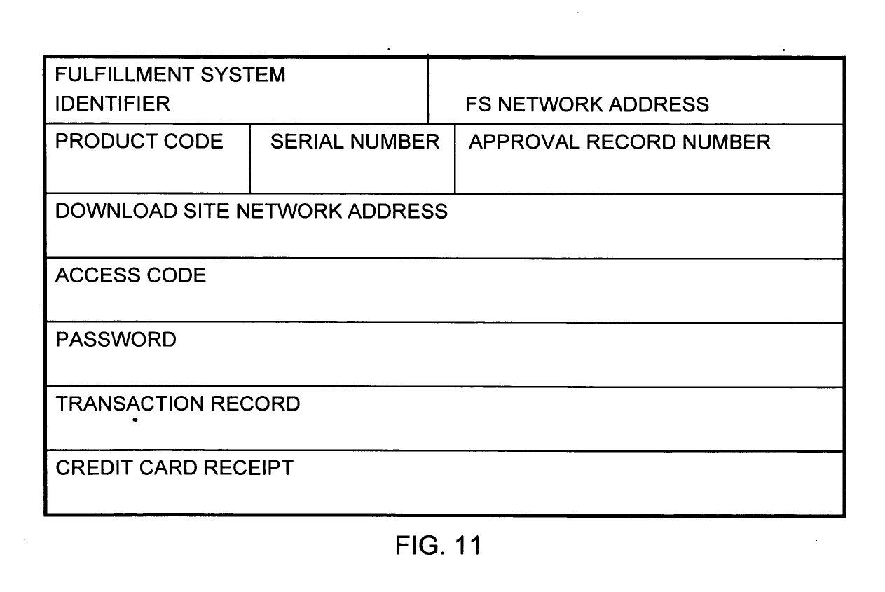

Referring now generally to the Figures and particularly to FIG. 11, FIG. 11 is a schematic diagram of a fulfillment electronic message containing information that enables the client system 6 to receive a download of a purchased and externally stored software program ESW.1-ESW.N. The fulfillment electronic message (hereafter, “fulfillment message”) may be generated by an Fsystem 2 or an Osystem 4, or by one or more Fsystems 2 and/or Osystems 4 in combination. The fulfillment message may be sent from an Osystem 4 to the client system 6 to enable the client system 6 to identify an Fsystem 2 or Osystem 4 from which a purchased external software program ESW.1-ESW.N and initiate and complete a download of a purchased external software program ESW.1-ESW.N. The fulfillment message includes (a.) a fulfillment system identifier FID of an Fsystem 2 that has approved a purchase request, (b.) an FS network address FNA of the referenced fulfillment system, (c.) a product/service code PID of the purchased software program ESW.1-ESW.N, (d.) a serial number of the specific copy of the external software program ESW.1-ESW.N approved for purchase, and (e.) an approval record number associable with the financial transaction of the purchase of the requested software program ESW.1-ESW.N. The fulfillment message further includes (a.) a network address of an Osystem 4 or an Fsystem 2 from which the purchased external software ESW.1-ESW.N may be downloaded, (b.) an access code used to authorize access to the Osystem 4 or Fsystem 2 addressable at the download site network address, and (c.) a password that enables the user to run the purchased external software program ESW.1-ESW.N after download and by means of the client system 6. The fulfillment message may optionally also include a transaction record of the approval of the download of the purchased external software ESW.1-ESW.N and/or a credit card receipt of the purchase of the external software program ESW.1-ESW.N referenced in the fulfillment message.

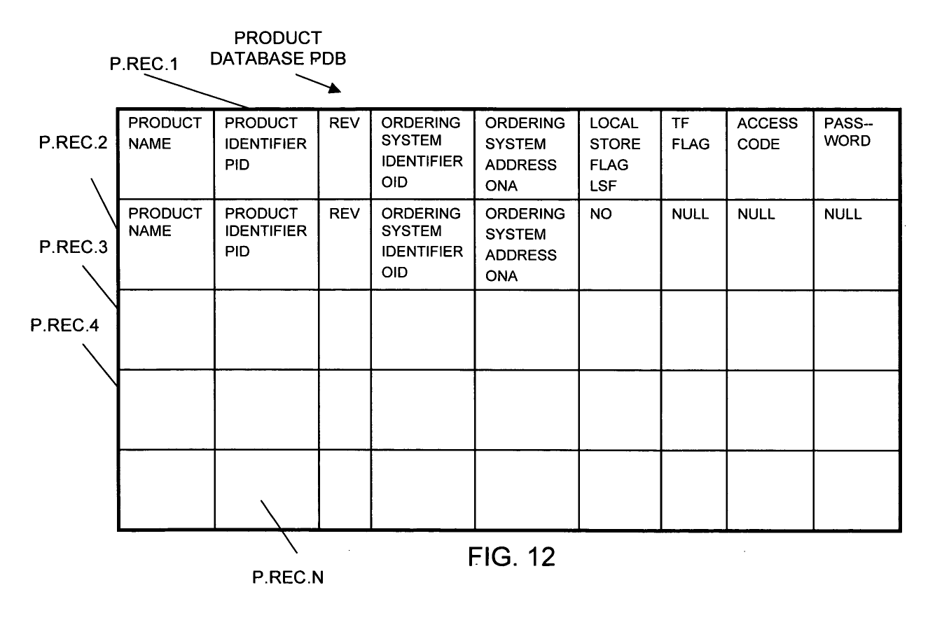

Referring now generally to the Figures and particularly to FIG. 12, FIG. 12 is a schematic of a product software database PDB maintained by a client system 6. The product software database PDB includes a plurality of product records P.REC.1-P.REC.N, wherein each product record P.REC.1-P.REC.N may include a product name, a product identifier PID, a revision level indicator REV, an ordering system identifier OID of on Osystem 4 to which a purchase request message may be transmitted, and a network address ONA of the indicated ordering system Osystem 4. The product identifier PID may identify (1.) a good, (2.) service, (3.) a software product SW.1-SW.N stored fully or partially within the client system 6, and/or (4.) an externally stored software program ESW.1-ESW.N that is stored and available for download from an Osystem 4 and/or an Fsystem 2. A product record P.REC.1-P.REC.N may further include a local store flag LSF that may indicate that a software product SW.1-SW.N identified by the product identifier PID is locally stored on the client system 6. The product software database PDB may further include (a.) an offline time limitation access parameter TF, (b.) an access code, and/or (c.) a password that is associated with an software product SW.1-SW.N and/or external software program ESW.1-ESW.N identified by the product identifier PID of the same product record P.REC.1-P.REC.N.

It is understood that one or more product records of the product software database may identify a good or service that does not include a software download to the client system 6 and that do not therefore include a positive local store flag LSF, and may include null vales for a time limitation parameter TF, an access code, and/or a password. The second product record P.REC.2 indicates a good or service that may be purchased in accordance with the method of the present invention and does not include a software download in fulfillment of its purchase.

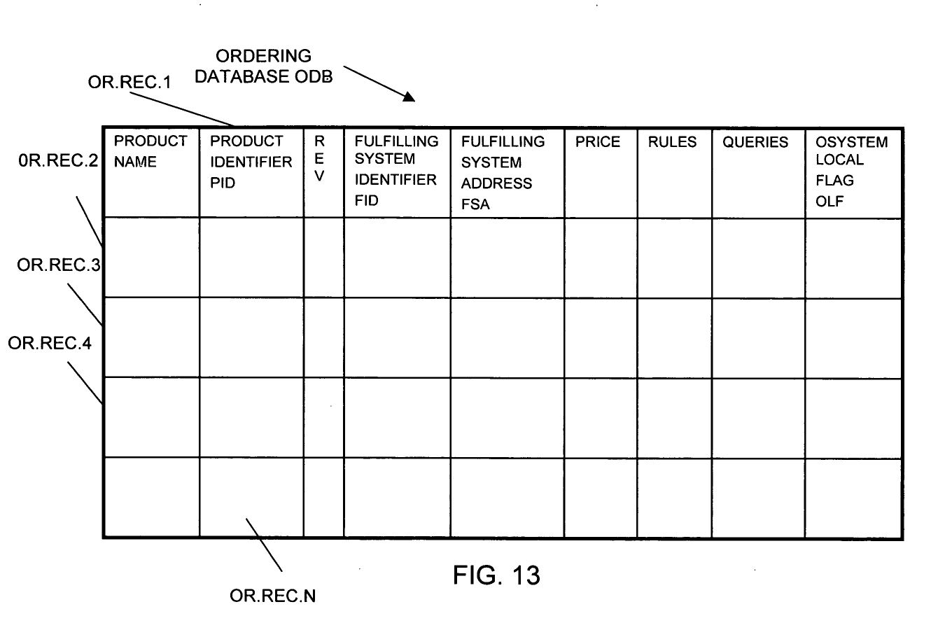

Referring now generally to the Figures and particularly to FIG. 13, FIG. 13 is an ordering software database ODB that is maintained by a host Osystem 4. The ordering system database ODB contains a plurality of ordering records OR.REC.1-OR.REC.N, wherein each ordering record OR.REC.1-OR.REC.N may include (a.) a product/service name, (b.) a product/service identifier PID, (c.) a revision level REV of the identified product or service, (d.) a fulfillment system identifier FID that identifies an Fsystem 2 from which a purchase of identified product or service indicated by the product/service identifier PID may be purchased, and (e.) a network address FSA of the Fsystem 2 identified in the FID data field of the same record OR.REC.1-OR.REC.N. Each ordering record OR.REC.1-OR.REC.N may further include a price of the service or product identified by the product/service identifier PID of the same ordering record OR.REC.1-OR.REC.N, (b.) rules that direct the client system 6 in enabling or limiting access to the product or service identified by the product identifier PID, (c.) queries that may be posed to the user in the process of accepting a purchase request, and (d.) an Osystem local flag OLG that may indicate when an external software program ESW.1-ESW.N identified by the product identifier PID of the same ordering record OR.REC.1-OR.REC.N is locally stored on the hosting Osystem 4 and may be downloaded from the hosting Osystem 4 and to the client system 6.

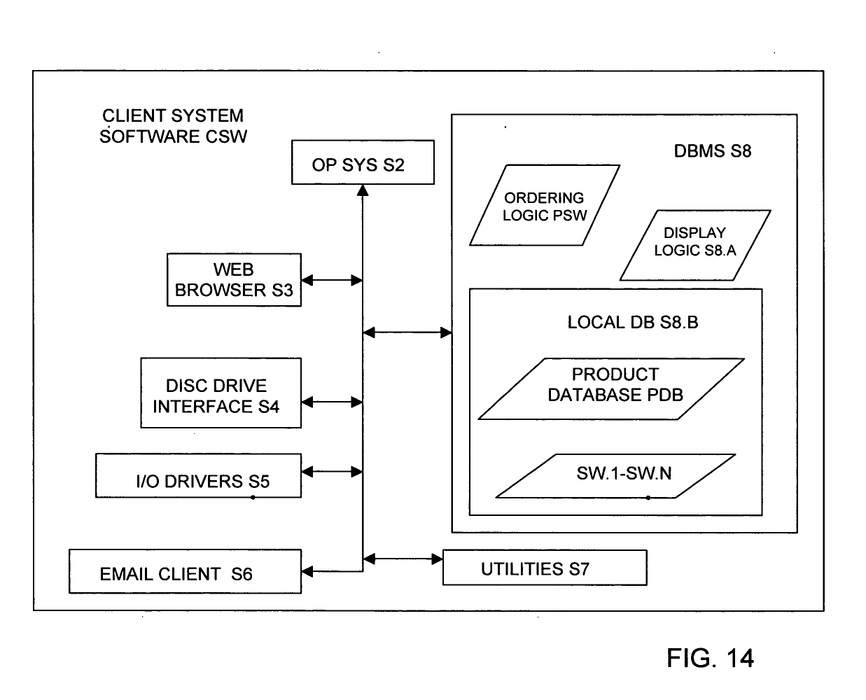

Referring now generally to the Figures and particularly to FIG. 14, FIG. 14 is a schematic diagram of the client software CSW of the client system 6. The client software CSW includes an operating system S2, a web browser S3, a disc drive interface software S4, and additional input and output software drives that enable information and selection input by the user via the input module 24 and presentation of information to the user via the video display module 16. The client software CSW also includes utilities software program S7 that enable the operations of the client system 6 and a database management system S8. The database management system S8 (hereafter, “DBMS” S8) includes (a.) the purchasing software client PSW, (b.) a display logic software code S8.A that enables the presentation of queries to the user by means of the video display module 16, and (c.) a local database S8.B. The local database S8.B includes the product software database PDB and optionally one or more software products SW.1-SW.2.

The DBMS S8 might be or comprise, in singularity or combination, (1.) an object oriented database and an Object Oriented DBMS, (2.) an IBM DB2 Universal Database™ server (in Linux, UNIX®) marketed by IBM Corporation of Armonk, N.Y.; (3.) WINDOWS™ operating system environments marketed by Microsoft Corporation of Redmond, Wash.; (4.) a relational database, such as an SQL Server Yuko™ relational database software as marketed by Microsoft Corporation of Redmond, Wash.; (5.) an Oracle Database 11g™ relational database software as marketed by Oracle Corporation of Redwood Shores, Calif.; and/or (6.) multiple data sources to which the client query application sends queries.

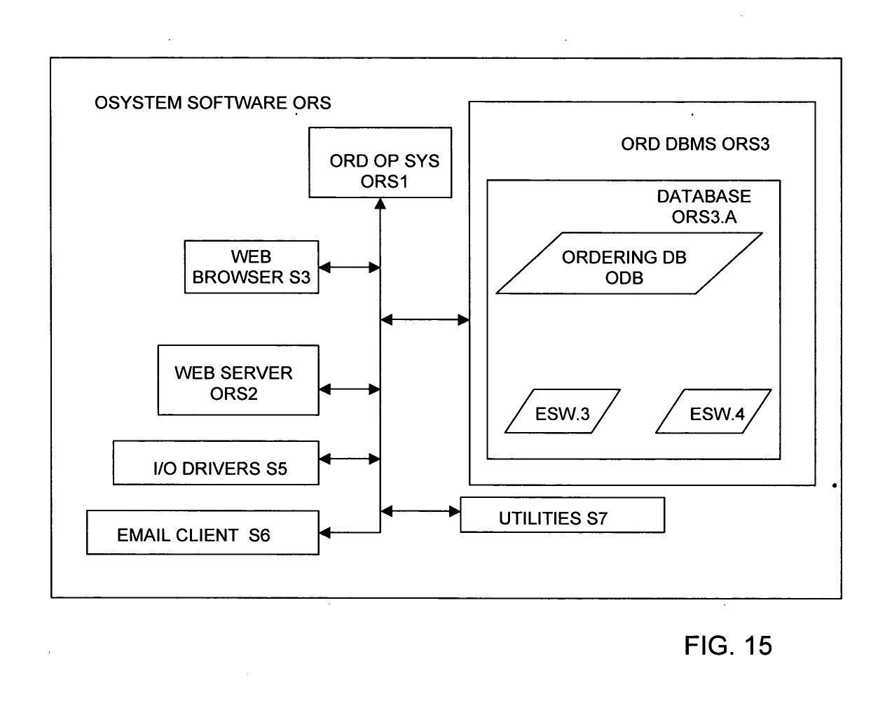

Referring now generally to the Figures and particularly to FIG. 15, FIG. 15 is a schematic diagram of an Osystem software ORS of an Osystem 4. The Osystem software ORS includes an operating system ORS. 1, a web browser S3, a web server ORS2, a disc drive interface software S4, and additional input and output software drivers S5 that enable information and selection input by the user via the input module 24 and presentation of information to the user via the video display module 16.

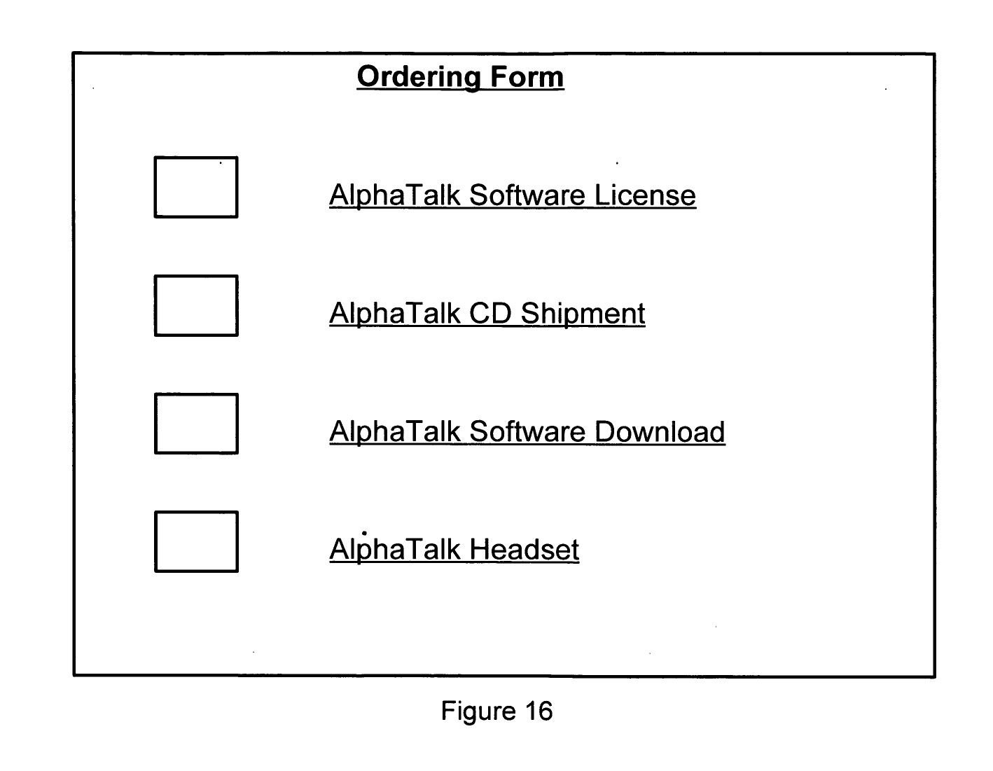

The web server ORS2 and the email client S6 enable the hosting Osystem 4 to format and transmit fulfillment messages of FIG. 11 and query screens of FIGS. 16, 17 and 18 to the client system 6.

The Osystem software ORS also includes utilities software program S7 that enable the operations of the hosting Osystem 5 and an Osystem database management system ORS3 (hereafter, “ODBMS” ORS3). The ODBMS ORS3 includes an Osystem database ORS3.A, the ordering data base ODB, an Osystem local database OLDB, and one or more external software programs ESW.3 or ESW.4.

The ODBMS ORS3 might be or comprise, in singularity or combination, (1.) an object oriented database and an Object Oriented DBMS, (2.) an IBM DB2 Universal Database™ server (in Linux, UNIX®) marketed by IBM Corporation of Armonk, N.Y.; (3.) WINDOWS™ operating system environments marketed by Microsoft Corporation of Redmond, Wash.; (4.) a relational database, such as an SQL Server Yukon™ relational database software as marketed by Microsoft Corporation of Redmond, Wash.; (5.) an Oracle Database 11g™ relational database software as marketed by Oracle Corporation of Redwood Shores, Calif.; and/or (6.) multiple data sources to which the client query application sends queries.

Referring now generally to the Figures and particularly to FIG. 16, FIG. 16 is a screen shot of a product/service ordering menu as visually presented by the video display module 16 of the client system 6. The user is enabled by the display logic S8.A and the ordering logic software PSW to populate and generate a purchase message by selecting from the displayed menu by means of the input module 24. The user may select from the displayed menu a purchase of (a.) a software license, (b.) a software copy written onto a CD-ROM product that could be mailed to the user, (c.) a software download, and/or (d.) a physical product, e.g., an audio output head set.

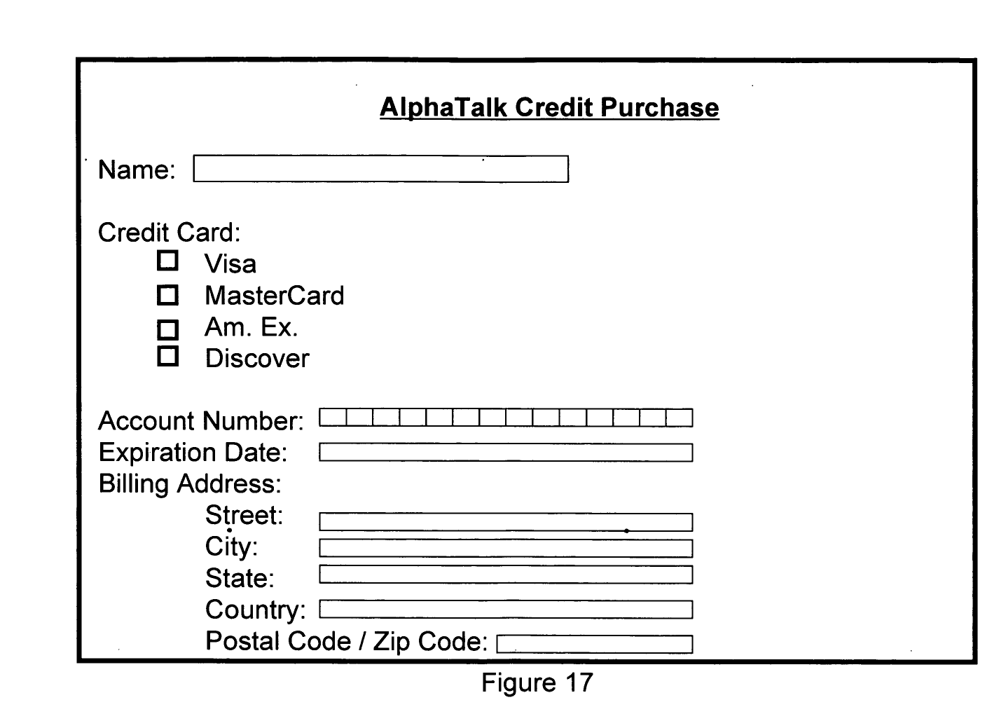

Referring now generally to the Figures and particularly to FIG. 17, FIG. 17 is a screen shot of a credit information input form as visually presented by the video display module 16 of the client system 6. The user may populate the input fields of the credit information input form with credit account and billing information. The client system 6 may further populate a purchase message with the information provided by the user by means of entering information into the credit information input form by means of the input module 24.

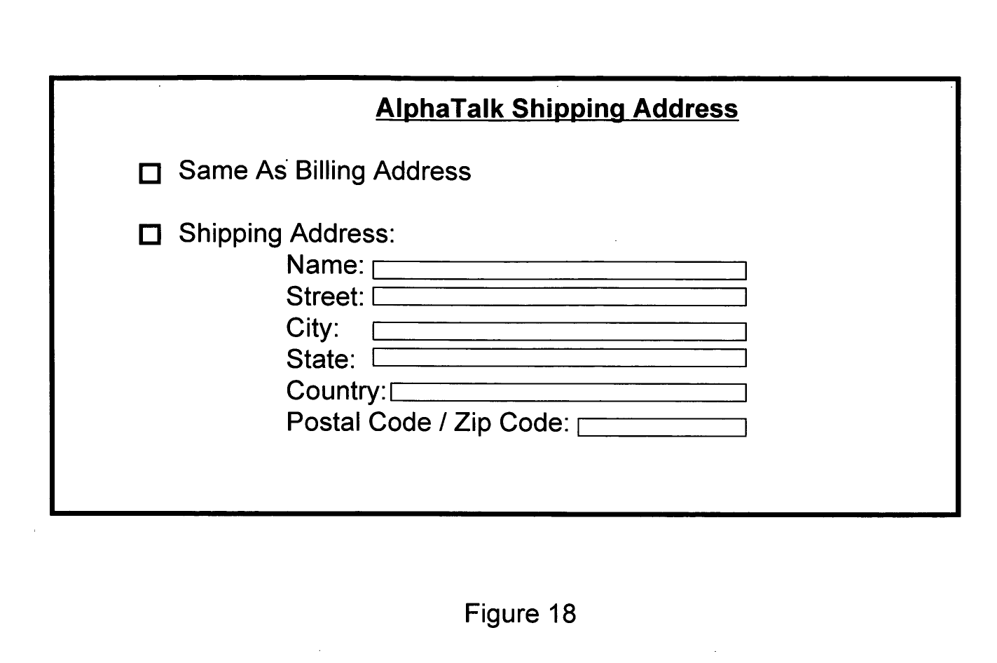

Referring now generally to the Figures and particularly to FIG. 18, FIG. 18 is a screen shot of a shipping information input form as visually presented by the video display module 16 of the client system 6. The user may populate the input fields of the shipping information input form with shipment address information. The client system 6 may further populate a purchase message with the information provided by the user by means of entering information into the shipping information input form by means of the input module 24.

The foregoing disclosures and statements are illustrative only of the Present Invention, and are not intended to limit or define the scope of the Present Invention. The above description is intended to be illustrative, and not restrictive. Although the examples given include many specificities, they are intended as illustrative of only certain possible embodiments of the Present Invention. The examples given should only be interpreted as illustrations of some of the preferred embodiments of the Present Invention, and the full scope of the Present Invention should be determined by the appended claims and their legal equivalents. Those skilled in the art will appreciate that various adaptations and modifications of the just-described preferred embodiments can be configured without departing from the scope and spirit of the Present Invention. Therefore, it is to be understood that the Present Invention may be practiced other than as specifically described herein. The scope of the Present Invention as disclosed and claimed should, therefore, be determined with reference to the knowledge of one skilled in the art and in light of the disclosures presented above.

1. In an electronic communications network comprising a client system, an order processing computer and a plurality of fulfillment systems, a method for processing purchase requests, the method comprising:
providing a managed client with a user interface having a navigation software tool on the client system to a user, the user interface enabling a user to place purchase requests via the client system;
accepting at least one purchase request by the client system to the order processing computer;
when the client system is not in communication with the order processing computer, temporarily enabling the client system to fulfill the purchase request; and
when the client system is in communication, enabling the order processing computer to direct at least one fulfillment system to execute at least one aspect of the at least one purchase request, wherein the at least one fulfillment system takes on action from the group consisting of authorizing an execution of a software by the client system, authorizing a webservice, authorizing a download of data to the client system, electronically transmitting an authorization code, directing a shipment of a product, directing a mailing of a hard copy certificate, authorizing a consumer service, authorizing a business service, authorizing a recordation of a document, and issuing a notification.

2. The method of claim 1, wherein the method further comprises a receipt by the order processing computer of a billing authorization associated with the at least one purchase request from the client.

3. The method of claim 2, wherein the method further comprises the order processing computer completing a financial transaction authorized by the billing authorization prior to direction of the at least one fulfillment system by the order processing computer.

4. The method of claim 1, wherein the electronic communications network comprises the Internet.

5. The method of claim 4, wherein the download of data is streamed via the Internet and to the client system.

6. The method of claim 1, wherein the user interface comprises a webpage.

7. The method of claim 1, wherein the order processing computer authorizes execution of a software, the software substantially stored on the client system prior to transmission of the at least one purchase request.

8. The method of claim 7, wherein the order processing computer is enabled to authorize execution of the software, whereby no intermediation of a fulfillment system is required to fulfill a purchase request to execute the software.

9. The method of claim 7, wherein the software is substantially stored on a hard disc of the client software prior to generation of the at least one purchase request.

10. A method for facilitating purchasing transactions using the Internet, the method comprising:
providing a managed client with user interface and navigation via a client system of the Internet, whereby the user may purchase access to or ownership of goods or services;
enabling the user interface to provide a unified user experience, wherein the user may purchase both (1.) authorization to a service enabled by a software stored on the client system prior to an authorization purchase by the user and (2.) an additional good or service purchased via the Internet within the unified user experience; and
an order processing computer, the order processing computer comprised within the Internet and configured to (1.) accept a purchase order transmitted from the client system, (2.) enable authorization to the service enabled by the software stored on the client system, and (3.) direct the Internet to enable fulfillment of an additional aspect of the purchase order.

11. The method of claim 10, wherein the method further comprises a receipt by the order processing computer of a billing authorization associated with the at least one purchase request transmitted from the client.

12. The method of claim 11, wherein the method further comprises the order processing computer completing a financial transaction authorized by the billing authorization prior to directing the Internet to enable fulfillment of an additional aspect of the purchase order.

13. The method of claim 11, wherein the software is substantially stored on a hard disc of the client software prior to the receipt by the order processing computer of a billing authorization

14. The method of claim 10, wherein the user interface further comprises a webpage.

15. The method of claim 10, wherein the user is enabled to purchase a download of data streamed via the Internet and to the client system.

16. A computer network, the computer network communicatively coupled with the Internet, and the computer network comprising:
a client system, the client system communicatively coupled with the Internet and comprising means to generate a unified user experience for purchasing goods and services via the Internet; and
an order processing computer, the order processing computer configured to accept purchase requests from the client system and to direct the client system and one or more computational assets of the Internet to fulfill purchase requests generated from the client system interface, wherein a software stored on the client system at least partially fulfills the purchase request.

17. The computer network of claim 16, wherein the order processing computer is further configured to authorize a user access to a software stored on the client system prior to issuance of a purchase request.

18. The computer network of claim 17, wherein the software is stored on a hard disc of the client system prior to issuance of a purchase request.

19. The computer network of claim 18, wherein the computer network further comprises means to complete a financial transaction authorized by a user generated billing authorization prior to authorization of fulfillment of an associated purchase request.

20. A computer-readable medium having computer-executable components for providing a web page comprising a consistent user interface enabled to direct the computer system to execute the method of claim 1.
